(19) United States
(12) Patent Application Publication
(10) Pub. No.: US 2021/0032075 A1
(43) Pub. Date: Feb. 4, 2021

(54) METHOD AND SYSTEM FOR AUTOMATED CONFIGURATION LEARNING FOR DIGITAL ELEVATOR IN-CAR DISPLAYS AND VOICE ANNUNCIATORS

(71) Applicant: thyssenkrupp Elevator Innovation and Operations GmbH, Essen (DE)

(72) Inventors: Matthew Muncy, Memphis, TN (US); Chih-Hung Aaron King, Sharpsburg, GA (US)

(73) Assignee: thyssenkrupp Elevator Innovation and Operations GmbH, Essen (DE)

(21) Appl. No.: 16/857,754

(22) Filed: Apr. 24, 2020

Related U.S. Application Data
(60) Provisional application No. 62/879,902, filed on Jul. 29, 2019.

(51) Int. Cl. B66B 1/34; B66B 1/46; B66B 3/02; B66B 3/00

(52) U.S. Cl. CPC B66B 1/3461; B66B 1/463; B66B 3/02; B66B 2201/463; B66B 1/468; B66B 2201/4623; B66B 3/008

(57) ABSTRACT

Methods, systems, and control devices may be employed to configure an in-car display of an elevator system based on a learning procedure. One example method may involve inputting information required for the learning and starting the learning procedure for installing or updating a configuration of the in-car display. The learning procedure may include the steps of gathering floor information of all floors of the elevator system and generating a configuration of the in-car display based on the gathered floor information. The information required for the learning procedure may include at least one of an access authorization code or a total number of floors accessible to the elevator system.

### CROSS REFERENCE TO RELATED APPLICATION

This application is a U.S. Non-Provisional Patent Application, which claims priority to U.S. Provisional Application No. 62/879,902, filed Jul. 29, 2019, the entire contents of which are incorporated herein by reference.

### FIELD

The present disclosure generally relates to methods and systems for configuring in-car displays of cabin operating panels and/or in-car voice annunciators in elevators.

### BACKGROUND

Based on U.S. Pat. No. 8,688,664 B2, an in-car or in-cabin digital elevator display unit is known that provides information to passengers. The elevator display unit also shows floor-specific information, such as the name of a particular floor, a list of tenants or residents living on that floor, or any other information associated with the particular floor. Before it can display this information, the elevator display unit must somehow acquire the information. This can be done by programming each elevator display unit initially at the time of installation.

One difficulty with this approach is that floor information is not static. For instance, as tenants change, information must constantly be updated. Each elevator display unit in zo each elevator in a building can be reprogrammed every time a change is required.

However, for a property manager who manages numerous buildings, some of which may be quite remote from one another, this can be a laborious undertaking.

Further, U.S. Patent Publication No. 2007/0246306 A1 discloses a method for setting floor associations of a plurality of operating units of an elevator system or installation. The operating units are panels that are provided in an access region of each floor to the elevator system and are distributed over a plurality of floors. The operating units can be activated by transmission of an activation signal from a transmitter unit. According to the described method, an elevator car is moved to a predetermined floor and the operating unit allocated to that floor is activated. The position data that describe the floor in which the operating unit is located are communicated from a transmitter unit located at the elevator car to the operating unit. The transmitted position data are stored in the operating unit or in an elevator control system. The position data contain details of an underlying floor of the building, such as a floor number and a designation of an access door to the elevator system. The elevator control system thus can recognize, upon issuance of a destination call via the operating unit, at which floor and in which area of the floor access by a person to be conveyed is located. A setting program is provided that enables travel to all floors for the purpose of association of the individual operating units. In order to achieve setting of the floor associations of all operating units for all floors, these steps are repeated for all floors present in the respective building.

Further, U.S. Pat. No. 10,303,744 B2 teaches creating a kiosk database including kiosk data, where the kiosk data outline width and height of a primary display area and a set of destination floors associated with a lift destination dispatch kiosk. A computing structure remote from the lift destination dispatch kiosk is used to automatically access the kiosk data in the kiosk database, calculate height of the floor button portion using the height of the primary display area, generate a floor button layout, and communicate the floor button layout from the computing structure to the lift destination dispatch kiosk to cause the floor button layout to be published on a display, where a network interface zo of the computing structure allows the floor button layout to be previewed before the floor button layout is communicated from the computing structure to the lift destination dispatch kiosk.

In addition, in WIPO Patent Publication No. WO2017/016937 A1 an elevator arrangement for automatically executing a fixture position learning procedure performed by an elevator control is described. The elevator arrangement automatically determines position information for all fixtures included in the elevator arrangement. The fixtures are located at various floors within a building and each fixture comprises a pressure sensor for sensing an absolute environmental pressure. The position information for the fixtures is thus based on the environmental pressure.

Such in-car elevator display systems for call input are becoming more desirable as the prevalence of touchscreen interfaces increases. Yet the configuration of in-car displays (ICDs) of respective cabin operating panels (COPs), in view of the corresponding graphical and/or audible user interface (AUI) elements, requires significant time investment to set-up or layout corresponding touchscreen buttons and/or corresponding audible voice annunciators. In addition, the ICDs and/or voice annunciators must be configured to display a specific number of buttons with correct floor labels as well as the correct names of each floor of the underlying building. A voice annunciator of an AUI must also rely on a correct configuration of corresponding audio files to announce when voice annunciation is activated. For example, if a “Floor 1” needs to be displayed as “L” on a virtual button, a corresponding voice announcement needs to announce the letter “L” as well.

At present, all these configurations are configured manually via a dedicated configuration tool that is used during the elevator engineering or production process in an elevator factory. This configuration represents an additional process and thus causes additional production costs. In addition, if a customer (e.g., a building manager) wants to change the configuration, such as the identifier for Floor 1 from “L” to “1,” a field technician or field engineer would need to use a configuration tool to update the ICDs of each elevator car. Such configuration tool is commonly a separate computer system zo that cannot be connected to an ICD. Consequently, a technician would be required to manually change the configuration, download a corresponding updated configuration file, go to the building, put each car into service mode, and then update the ICDs of each elevator car. This causes time-extensive interruptions to elevator service, and such configuration processes are prone to errors.

In view of the foregoing, there exists a need for more efficient updating of floor information for display by elevators. To that end, a need exists for methods and systems that provide the capability of real-time installing or updating of floor names and other configurations for in-car elevator displays and voice annunciators.

### BRIEF DESCRIPTION OF THE DRAWINGS

FIG. 1 is a schematic view of an example display panel of an in-car control cabinet of an elevator.

FIG. 2 is a flow diagram according to an example method of the present disclosure.

FIG. 3 is a flow diagram depicting various steps according to another example method.

FIG. 4 is a flow diagram representing an exemplary learning process being applied or executed during installation of an elevator system, according to yet another example method of the present disclosure.

FIG. 5 is a flow diagram representing another example of a learning process being executed during installation of an elevator system, according to still another example method of the present disclosure.

FIG. 6 is a flow diagram depicting yet another example method in which a learning process is executed during normal operation of an elevator system.

FIG. 7 is block diagram depicting an example system of the present disclosure.

### DETAILED DESCRIPTION

Although certain example methods and apparatuses are disclosed herein, the scope of coverage of this patent is not limited thereto. On the contrary, this patent covers all methods, apparatuses, and articles of manufacture fairly falling within the scope of the appended claims either literally or under the doctrine of equivalents. Moreover, those zo having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

In some examples, a learning system to be implemented in an in-car display (ICD) may learn configurations or configuration changes through communication with an elevator control system. Although the present disclosure refers to the ICD generally, those having ordinary skill in the art will recognize that the ICD may comprise various subcomponents such as an ICD controller, for example and without limitation. Such configurations or configuration changes may be based at least in part on car position indicator (CPI) information, as explained below, which describes, is based on, and/or relates to a car's position, speed, acceleration, origin, and/or destination(s) within a shaft. It should be understood that the elevator control system may continuously or io periodically provide CPI information to the ICD, even when/where not explicitly recited below. Further, such learning eliminates the need for a dedicated configuration tool for installation of an elevator system or for quick configuration updates such as changing car floor labels. In addition, the example methods of the present disclosure allow for a true plug-and-play solution that considerably reduces the amount of effort or field labor to install an underlying elevator system. Still further, such example methods and systems eliminate the risk of receiving incorrectly configured ICDs from the factory.

Some aspects of the present disclosure are directed to elevator systems, and some aspects of the present disclosure are directed to methods for configuring ICDs of elevator systems based on a learning procedure. One example method comprises the following steps:
inputting (or receiving) information required for the learning; and
starting the learning procedure for installing or updating the configuration of the ICD, wherein the learning procedure includes gathering floor information of all floors of the elevator system, and
generating a revised or updated configuration of the ICD based on the gathered floor information.

Other aspects of the present disclosure are directed to methods where the information required for the learning procedure includes an access authorization code and/or the total number of floors accessed by the elevator system. The floor information of all floors of the elevator system may be gathered from an elevator control system. The installing or updating of the configuration of the ICD may include generating a graphical user interface (GUI) touchscreen implementation of virtual user buttons for receiving car calls and/or corresponding audio signals of an underlying audible user interface (AUI). It should be understood that the virtual buttons may in some cases be touchless or at least have the capability to be activated without physical contact (e.g., gesture-based io triggering, IR sensor triggering, light curtain triggering). Further, the audio signals may be intended to be broadcast in an elevator car, and the audio signals may correspond to at least one of the floor information or CPI information.

The configuration of the ICD may concern, for example, displaying floor numbers or names on an elevator car position indicator as floors are passed, indicating a destination floor number by the GUI and/or the AUI, audio signals to be broadcast by the AUI, and/or indicating a list of tenants or residents occupying the destination floor. The configuration of the ICD may be based on the CPI information and/or the floor information such that at least two virtual buttons are configured for display on a touchscreen portion of the ICD for floors where an elevator car may be accessible via zo one of two different doors. Likewise, the configuration of the ICD may be based on the

CPI information and/or the floor information such that a virtual button is hidden or, if configured for display on the touchscreen portion of the ICD, is indicated as being locked out for a floor that is inaccessible or otherwise unavailable as a destination floor.

In some examples, the step of gathering floor information of all floors of the elevator system may include running the car from the first floor to the top floor, gathering floor information for each floor being passed by the car, and examining or determining based on CPI information, for example, whether the top floor is reached by the car and, if the top floor is not reached, then continuing with running the car from the first floor to the top floor and, if the top floor is reached, generating a revised configuration of the ICD, based on CPI information and/or the gathered floor information.

Still other aspects of the present disclosure are directed to a method where the learning procedure executed during installation of the elevator system may be divided into three processing parts. The first processing part may in some cases be associated with or performed by an installer. The second processing part may in some cases be associated with or performed by an ICD of a cabin operating panel (COP). The third processing part may in some cases be associated with or performed by an elevator control system. The three processing parts may execute the following process steps of the learning procedure:

the installer powers on the COP, enters an access authorization code, enters the total number of floors accessed by the elevator system, and initiates the learning procedure;

the ICD puts a first call to the first floor of the building being accessed by the elevator system and puts a second call to the top floor of the building being accessed by the elevator system; and the elevator control system, according to the first call, moves the car to the first floor and, according to the second call, moves the car to the top floor, wherein during movement of the car from the first floor to the top floor the elevator control system provides floor information for each floor being passed by the car to the ICD, wherein the ICD may check whether the car has reached the top floor and, if this condition is fulfilled, generate respective buttons for the recognized floors and update the voice annunciator accordingly.

Other aspects of the present disclosure are directed to methods where the learning procedure executed during normal operation of the elevator system, during which the elevator system transports passengers or is at least available and prepared to transport passengers, is divided into four processing parts. The first processing part may in some cases be associated with or performed by a technician. The second processing part may in some cases be associated with or performed by a user. The third processing part may in some cases be associated with or performed by an ICD of a COP. The fourth processing part may in some cases be associated with or performed by an elevator control system. In some examples, the following process steps of the learning procedure may be performed in accordance with the four processing parts:
a configuration change is requested, in some cases by a technician, to existing elevator labels during normal operation of the elevator system;
the user presses a button of the ICD to go to a specific floor;
the ICD puts a corresponding call to the destination floor; and
the elevator control system, according to the corresponding call, moves the car to the destination floor,
wherein the elevator control system checks whether the car has reached the top floor and, as long as this condition is not fulfilled, the elevator control system provides floor information for each floor as it is passed by the car, wherein based on CPI information and the sent floor information the ICD compares the provided information of a currently passed floor with the floor's current respective configuration, wherein if the comparison reveals that the current configuration is different from or inconsistent with the information of the currently passed floor the ICD updates the buttons and the voice annunciator of the COP in order to match the new value.

A slight variation of the example method disclosed above, which can also be performed during normal operation of the elevator system, may involve determining whether the elevator car has passed all of the floors that are accessible to the elevator system in a predetermined time period (e.g., an hour, a day, etc.). Until the elevator car passes all of the floors during the predetermined time period and hence until the ICD receives current floor information for all of the floors during the predetermined time period, the elevator control system may continue to provide the floor information for each floor that the elevator car passes while moving the elevator car in response to additional requests for travel until all floors are passed.

Yet further aspects of the present disclosure are directed to a learning system for the ICD device that includes the following components:
1. an ICD and
2. an elevator control system
   a. that is connected to the ICD via a serial connection
   b. and is configured with the floor labels for the car.

During an installation setup or a configuration update, the ICD may show that the elevator “is in learning mode” while the ICD is retrieving floor information.

According to another aspect, it may be determined whether there exist floors for which corresponding floor information is missing. From a property server, for example, data indicative of a floor for which the elevator lacks floor information is received. From a remotely-executed process, new floor information for the floor may be received and stored in a floor information database. From the property server, in addition, a request identifying the remote property may be received and an updated floor information for the remote property may be requested. The updated floor information may be retrieved from the floor information database. The received new floor information may include the name of a respective floor, for instance.

Further aspects of the present disclosure may be directed to a control system for controlling operation of an elevator system. The control system may enable zo configuration of an ICD of the elevator system based on the exemplary learning procedure referenced above. The control system may include an elevator control system that controls at least the operation of a motor of the elevator system. The control system may further include a car controller disposed on a side of an elevator car and connected to the elevator control system via a communication bus. The car controller may be connected to the ICD. The communication between the ICD and the car controller may be bi-directional. This control system or device enables the learning procedure to be executed by way of the ICD.

The disclosed methods and systems advantageously provide real-time updating capability for an ICD for use within an elevator system so that it can learn the floor label changes from communication with the control system or, more specifically, an elevator control system of the more-general control system. In view of its plug-and-play nature, these methods and systems can be utilized much more frequently than prior art methods and systems since the disclosed methods and systems will require less labor efforts or less configuration efforts over traditional methods and corresponding tools.

Furthermore, the continued configuration monitoring aspect of the system means that should a floor label or floor service need to be modified on the system the technician will io not need to notify an ICD of a COP. Rather, the COP itself will keep the configuration up to date. This simplifies the training requirements for field technicians since they will only need to know how to make the changes using the traditional field configuration tools that they understand well.

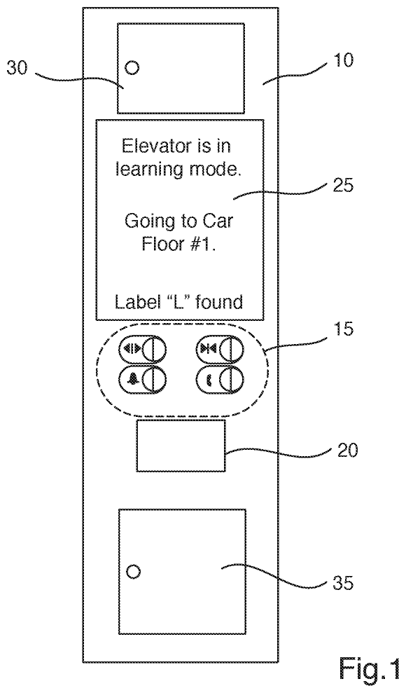

With respect now to the drawings, FIG. 1 depicts an example COP 10, which in some cases is arranged in-car with respect to an elevator system. The COP 10 comprises common user buttons 15 and a first operating display 20 for displaying, for example, a current floor number. The COP 10, in addition, comprises a second programming display 25 that is larger than the first display 20 and mainly used for elevator programming or configuration. These example displays 20, 25 of the COP 10 may also zo be known, more generally, as ICDs. On the upper area, the COP 10 further comprises a capped first compartment 30 for storing firefighters' emergency operation instructions. On the lower area, the COP 10 further comprises a capped second compartment 35 for storing general operating instructions, such as the maximum number of persons allowed, for instance.

As described in more detail below, the example elevator system may be programmed or configured by using the COP 10. In the presently depicted stage of the entire learning process, which is communicated to the user or programmer by the wording “Elevator is in learning mode,” the present car or cabin may go to a next car floor #1. The latter information is communicated to the programmer by the wording “Going to Car Floor #1.”

At the bottom of the programming display 25, it is communicated to the programmer that a label “L” is found being assigned to the current floor.

The example elevator systems described herein may also comprise out-of-car operating units, which may also be known as “landing operating panels” (LOPs), which are panels provided in an access region of each floor to the elevator system. The LOPs can be activated, which may involve awakening the LOP from a sleep mode and/or indicating the approach of the elevator car on the LOP, by transmission of an activation signal from a transmitter unit on the elevator car.

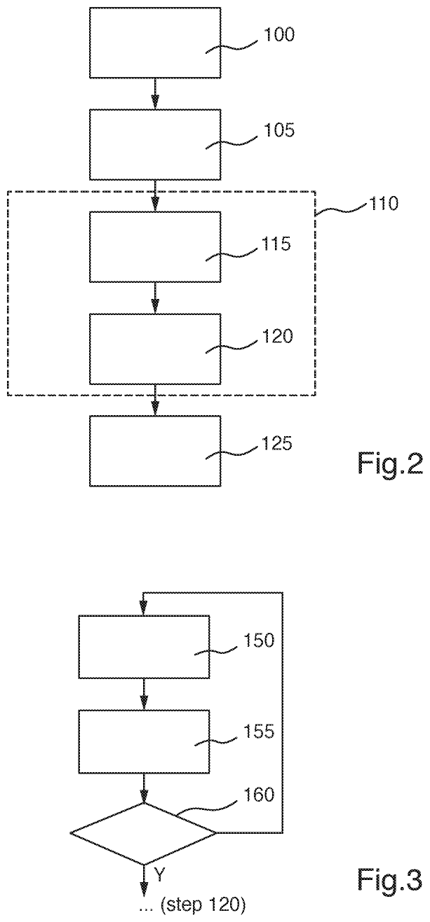

FIG. 2 shows one example method. In a first step 100, a “user” or an “installer” in io charge of installing or updating the configuration of an above-described COP 10 of an underlying elevator system inputs basic data required for that task, such as an access authorization code and/or the total number of floors of an underlying building being covered or serviced by the elevator system, for example, which data may be received by an ICD and/or an elevator control system. After input of this data, the ICD and the elevator control system may receive an instruction, in some cases from the user or the installer, to start 105 a learning procedure or process 110 for installing or updating the configuration of the COP 10.

The learning procedure 110 may include process steps 115 and 120. According to step 115, floor information of all floors is gathered from, for instance, the elevator control zo system. Based on CPI information and/or the gathered floor information, the configuration of the COP 10 may be generated 120 or, in some instances, updated, which in this example includes generating or updating a GUI implementation of the user buttons for display on a COP and the corresponding audio signals of an underlying AUI, such as underlying voice annunciator, for instance.

Generating or updating the configuration of the COP 10 may involve, at least in the present example, causing the GUI and/or the AUI to indicate to users or passengers CPI information such as floor numbers as they are passed and/or a destination floor number. In addition, the GUI and/or the AUI may present respective floor names and/or a list of tenants or residents living on the destination floor, or any other information associated with a particular floor.

In a final step 125, the learning procedure may be completed upon receiving a “completion” command or acknowledgement at the COP 10, which in some instances may come from the user or installer.

FIG. 3 shows further process steps according to another example method of the present disclosure. In this example, the above-described step 115 includes several further process steps 150-160, for example, by way of a subroutine.

According to step 150, the elevator control system may be engaged to run the car io (cabin) from the first floor to the top floor. According to step 155, floor information for each floor being passed by the car may be gathered via the elevator control system. CPI information may be used, for example, to display the current location of an elevator car on LOPs on landings at different floors or on ICDs. In examining step 160, it may be determined whether the top floor is reached by the car. If examination by step 160 reveals that the top floor is not yet reached, then the method may revert to step 150.

Otherwise, if the top floor is reached, the learning procedure may continue with the above-described step 120.

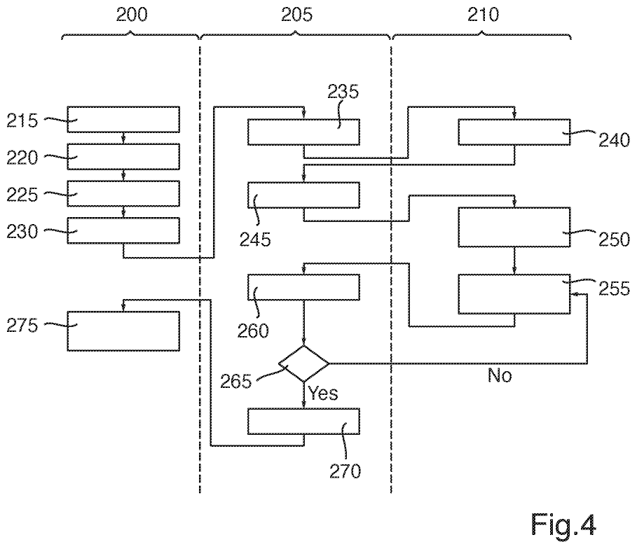

According to still another example method in FIG. 4, an elevator car may be moved to a predetermined floor and the LOP allocated to that floor may be activated. Floor zo information that describes the floor on which the LOP is located may be communicated from the transmitter unit on the elevator car to the LOP, which may be stored in the LOP or in a storage unit of an underlying elevator control system. The floor information may contain details of the floor number of the building and the designation of the access or an access door, for instance. The elevator control system thus may be able to recognize, upon issuance of a destination call being delivered by the LOP, at which floor and in which region of the floor access to a person to be conveyed is located.

The learning process during installation of the elevator system, which is depicted purely by way of example in FIG. 4 with a flow diagram, may be divided into three processing parts that may potentially be handled or executed by different entities that control or execute the relevant method steps. As a first instance, a human installer 200, which in the current example may be the programmer, starts and performs certain installation steps for the installation of the elevator system. As a second instance, an ICD 205 of the COP may be used to interact with the installer 200 and receive input from the installer 200. As a third instance, the elevator control system 210 may generally control physical operation of the elevator system.

In order to start the installation process based on the herein described learning approach, the installer 200 may manually power on 215 the COP and enter 220 a COP identification number for authorization purposes. Then the installer 200 may enter 225 the total number of floors of the underlying building to be accessed or serviced by the elevator system. After that, the installer may initiate 230 the learning procedure described below.

As a first step 235 of the learning procedure, the ICD 205 may put a call to the first (i.e., lowest) floor of the building being serviced by the elevator system. The elevator control system 210 may then move 240 the car to the first floor. As a next step 245 of the learning procedure, the ICD 205 may put a call to the top floor of the building being serviced by the elevator system, so that the elevator control system 210 moves 250 the car to the top floor.

During movement 250 of the car from the first floor to the top floor, the elevator control system 210 may send 255 the latest, or “current,” floor information for each floor being passed by the car. All the while, the elevator control system 210 may provide CPI information too. The data format of the CPI information, in some examples, is the known ASCII format. Exemplary ASCII characters or codes for the CPI are “↓B2↓” or “↑8”.

In the following step 265 it may be checked whether the car has reached the top floor. If not, step 255 may be repeated as long as the car has not yet reached the top floor. If step 265 reveals that the top floor has been reached by the car, the ICD 205 may generate 270 respective buttons for the recognized floors and update the voice annunciator accordingly for anticipated downward travel. Although some examples herein describe the ICD 205 as updating its configuration after floor information for all floors has been collected, it should be understood that the ICD 205 may in some cases update 260 its configuration based on the sent CPI information and/or floor information, continuously, periodically, intermittently, or as necessary.

The learning procedure according to some examples may be finished through acknowledgement 275 of completion of the entire configuration procedure, which in some cases may be initiated by the installer 200.

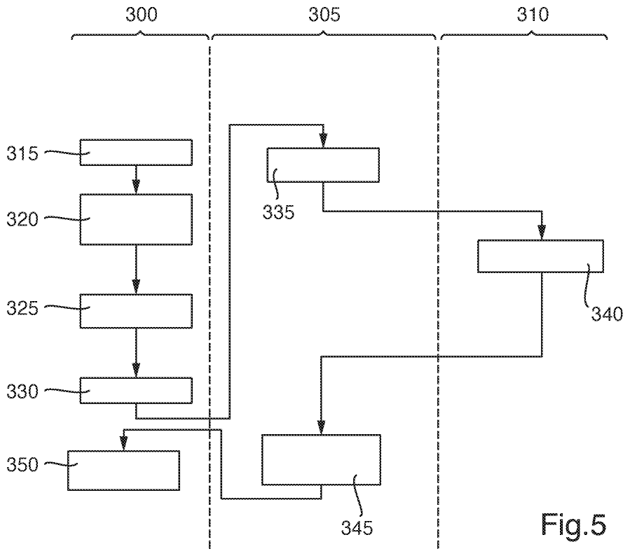

The flow diagram depicted in FIG. 5, which shows another example of the learning procedure during installation, may potentially be handled or executed by three io processing entities, including installer 300, ICD 305, and elevator control system 310.

The learning procedure according to the example represented by FIG. 5 may in some instances be easier to perform and thus implement than the example procedure disclosed with respect to FIG. 4.

The installation process based on learning may start when the COP is powered on 315, in some cases manually by the installer 300. The COP may then receive 320, in some cases from the installer 300, a COP identification number 320 and a number of floors 325. Thereafter, the learning procedure may be initiated 330.

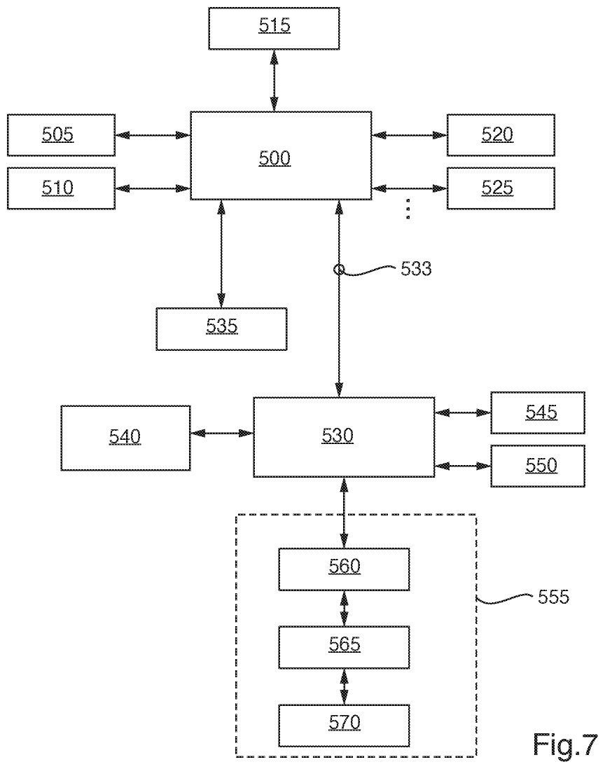

As a first step 335 of the learning procedure, the ICD 305 may request floor information from the elevator control system 310. The elevator control system 310 may then provide zo 340 all available floor information to the ICD 305, which can generate 345 the respective buttons and update the voice annunciator accordingly, as described above. Finally, completion of the procedure may be acknowledged 350 by, for example, the installer 300. The interaction between the elevator control system 310 and the ICD 305 can be implemented, for example, by way of a communication protocol run by a system such as the example shown in FIG. 7 and described below. The communication protocol may involve, for instance, the Controller Area Network (CAN) bus protocol.

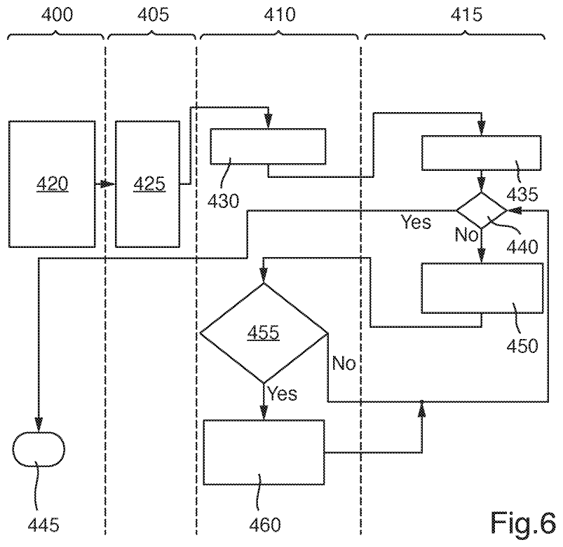

FIG. 6 depicts still another example learning procedure, which can be performed during operation of the elevator system and not only during its installation or configuration.

Four processing parts may be associated with or performed by different entities, namely, a technician 400, a user 405, an ICD 410, and an elevator control system 415.

At the beginning of the procedure, a configuration change 420 may be requested, in some cases by the technician 400, to existing elevator labels during normal operation of the elevator system. It may be further assumed that, in a next step, a user 405 presses 425 a button indicating his/her desire to go to a destination floor. The ICD 410 may therefore put 430 a corresponding call to the destination floor. As a reaction to this call, the elevator control system 415 may then begin to move 435 the car to the destination floor.

io In the following step 440, it may be checked whether the car has already reached the destination floor. Once the car reaches this destination floor, the learning procedure may be complete based on the gathered floor information and may be ended 445 manually by the technician 400. As long as the destination floor has not yet been reached by the car, the elevator control system 415 may send 450 the floor information for each floor passed by the car to the ICD. Based on this sent information, the ICD 410 may compare 455 the floor information of the floors that are passed with the respective configurations for those floors. If the check 455 reveals that the configuration is as expected, the procedure may revert to step 440 where it may be checked again whether the car has already reached the destination floor. However, if the check 455 reveals that zo the current configuration is different from the floor information of the floor being passed, the ICD 410 may update the buttons and the voice annunciator of the COP to match the new value. Thereafter, the procedure may revert to step 440 to check again whether the car has already reached the destination floor.

FIG. 7 shows an example main control system of an underlying elevator system wherein the main control system may be employed to configure or program operation of an elevator system. The main control system may include an elevator control system 500 that operates as a central controller of the entire elevator system. The elevator control system 500, at least to some extent, controls the operation of a synchronous motor 505 of the elevator system by which the at least one car or cabin is moved. Operation of the synchronous motor 505 may be controlled by an encoder 510. Communication between the elevator control system 500, on the one hand, and the motor 505 and the encoder 510, on the other hand, may be bi-directional.

The elevator control system 500 may be connected to an Ethernet card 515 by which operation of the elevator control system 500, and in some cases other control units described in the following as well, can be monitored remotely. The elevator control system 500 may also be connected to further subunits, such as a keyboard debugger 520 for enabling manual input of control parameters and a group control card 525. The group control card 525 allows for control of an elevator system comprising more than one elevator shaft, in order to coordinate operation of the at least two elevator shafts for a better operation performance and according improved passenger experience. However, as indicated by the dotted line, those having ordinary skill in the art will recognize that there can be even more subunits, such as a pre-opening door module, for example.

The main control system in FIG. 7 may further include a car control board (CCB) 530 that is disposed on a side of an elevator car or cabin and that controls various functions of an underlying elevator car, including, but not limited to, car arrival gong, car lighting control, car nudging, overload indicator, and buzzer alarming functions. The CCB 530 is connected to the elevator control system 500 via a CAN communication bus 533. zo Communication between the elevator control system 500 and the CCB 530 may also be bi-directional. In addition, the main control system may include a hall display board 535, which is also connected to the elevator control system and which may be positioned in a main hall or reception area of an underlying building.

The CCB 530 may be connected to an ICD board 540, which is positioned on a side of the elevator car and in some cases controls operation of an ICD 542 inside the car. It should be understood that communication between the ICD board 540 and the CCB 530 may be bi-directional, in contrast to the state of the art where communication is only unidirectional from the CCB 530 to the ICD 540. One reason for the bi-directional communication is that the ICD board 540 participates significantly in the learning process and thus may require the ability to deliver and/or to send control commands/requests to the CCB 530.

The CCB 530 may further communicate with controller subunits, such as a door controller 545 for controlling the opening and closing of the car doors, for example, or a voice announcer 550 for acoustically announcing actual elevator status information to the car passengers, as another example. However, communication may also occur with further subunits, such as a weighing sensor for preventing overload of the car caused by too many passengers or too many heavy objects to be transported by the car, for example.

Within the dotted line 555, there are shown further exemplary subunits that are positioned in a main operation panel or front door operation panel of the car and that communicate with the CCB 530, preferably bi-directionally as well. The example of FIG. 7 may also include, for instance, a multifunctional car control board 560 and an instruction board 565 for enabling an instruction input or another instruction board 570 for providing an instruction input expansion.

Of course, the disclosed methods and systems are merely exemplary. Those having ordinary skill in the art will recognize how to modify such methods and systems in various ways that are consistent with and covered by the underlying concept of the present disclosure.

What is claimed is:

1. A method for configuring an in-car display of an elevator system via a learning procedure, the method comprising:
receiving information required to initiate the learning procedure; and
starting the learning procedure for installing or updating a configuration of
in-car display, wherein the learning procedure comprises:
gathering floor information for all floors of the elevator system, and
rating the configuration of the in-car display based on the floor information that has been gathered.

2. The method of claim 1 wherein the configuration of the in-car display that is generated comprises:
virtual buttons for receiving car calls, the virtual buttons configured for display on a touchscreen portion of the in-car display, and
levator car position indicator that is based on car position indicator information, the elevator car position indicator configured for display on the in-car display.

3. The method of claim 2 wherein the configuration of the in-car display is based on the car position indicator information and/or the floor information such that at least one of the following:
at least two virtual buttons are configured for display on the touchscreen for floors where an elevator car may be accessible via two different doors; or
a virtual button is hidden or, if configured for display on the touchscreen, is indicated as being locked out for a floor that is inaccessible or otherwise unavailable as a destination floor.

4. The method of claim 2 wherein the learning procedure comprises generating audio signals to be broadcast in an elevator car, the audio signals corresponding to at least one of the floor information or the car position indicator information.

5. The method of claim 1 wherein installing or updating the configuration of the in-car display comprises generating a visual representation for a graphical user interface of the in-car display or an audio signal of an audible user interface.

6. The method of claim 1 wherein the configuration of the in-car display includes information about at least one of:
numbers or names of the floors;
a destination floor;
audio signals to be broadcast in the elevator car; or
a list of tenants or residents occupying the destination floor.

7. The method of claim 1 wherein the information required to initiate the learning procedure includes at least one of an access authorization code or a total number of floors that are accessible by the elevator system, wherein the floor information is gathered from an elevator control system.

8. The method of claim 1 wherein gathering the floor information for all the floors of the elevator system comprises:
moving an elevator car past all of the floors of the elevator system;
gathering the floor information for each floor that the elevator car passes as the elevator car passes each floor; and
determining whether the elevator car has past all of the floors of the elevator system, wherein if the elevator car has not past all of the floors of the elevator system then moving the elevator car past yet-to-be-passed floors, wherein if the elevator car has past all of the floors of the elevator system then generating the configuration of the in-car display based on the gathered floor information.

9. The method of claim 1 wherein the learning procedure is executed during installation of the elevator system, the method comprising:
providing power to a cabin operating panel;
receiving an access authorization code at the cabin operating panel:
receiving a total number of floors that are accessible by the elevator system at the cabin operating panel;
initiating the learning procedure;
putting a first call to a first floor and putting a second call to a top floor;
moving an elevator car to the first floor and then moving the elevator car to the top floor, wherein an elevator control system provides the floor information for each floor that the elevator car passes to the in-car display; and
checking whether the elevator car has reached the top floor, wherein if the elevator car has reached the top floor the in-car display generates the configuration of the in-car display based on the floor information that has been gathered.

10. The method of claim 9 wherein the in-car display puts the first call to the first floor and puts the second call to the top floor.

11. The method of claim 1 wherein the learning procedure is executed during normal operation of the elevator system as the elevator system transports passengers or is at least available and prepared to transport passengers, the method comprising:
receiving a change to the floor information of at least one of the floors;
receiving a request for an elevator car to travel to one of the floors during normal operation of the elevator system;
putting a call to the one of the floors;
moving the elevator car to the one of the floors;
receiving the floor information from an elevator control system for each floor that is passed by the elevator car while moving the elevator car to the one of the floors;
determining whether the elevator car has passed all of the floors that are accessible to the elevator system, wherein if the elevator car has not yet passed all of the floors then the elevator control system continues to provide the floor information for each floor that the elevator car passes while moving in response to additional requests for travel; and
comparing the received floor information with the configuration of the in-car display, wherein if the comparison reveals that the configuration of the in-car display differs from the received floor information then updating the configuration of the in-car display to match the received floor information.

12. The method of claim 11 wherein the change to the floor information of the at least one floor comprises a change to the floor label of the at least one floor.

13. The method of claim 12 wherein the configuration of the in-car display including a virtual button thereof is updated to match the received floor information, which received floor information corresponds to the change to the floor label of the at least one floor.

14. The method of claim 1 wherein the learning procedure comprises generating the configuration of an elevator car position indicator of the in-car display based on car position indicator information, wherein the configuration of the elevator car position indicator of the in-car display is updated periodically as an elevator car travels through a shaft.

15. The method of claim 1 comprising updating the configuration of the in-car display as updates to the floor information are received, wherein the updating occurs before the floor information for all floors has been gathered.

16. A system for configuring an in-car display of an elevator system based on a learning procedure, the system comprising:
an in-car display for an elevator car of the elevator system, wherein the in-car display is configured with a floor label for each floor that is accessible to the elevator system, wherein the in-car display is configured to indicate a learning mode and to display a destination floor to which the elevator car is traveling to retrieve current floor label information during installation of the elevator system or during an update to the elevator system;
an elevator control system that provides the current floor label information; and
a serial connection that connects the elevator control system to the in-car display.

17. The system of claim 16 wherein the elevator control system is configured to receive and fulfill requests to update the floor labels from a location that is remote to the elevator system.

18. The system of claim 16 comprising a voice annunciator, wherein the voice annunciator is configured to broadcast audio signals in the elevator car, wherein the audio signals are based on at least one of car position indicator information or floor information that is obtained as the elevator car passes each floor.

19. A main control system for controlling operation of an elevator system, wherein the main control system enables configuration of an in-car display of the elevator system based on a learning procedure, wherein the main control system comprises:
an elevator control system that controls at least operation of a motor of the elevator system;
an in-car display disposed on an elevator car, wherein an in-car display controller of the in-car display controls operation of the in-car display and executes the learning procedure; and
a car controller that is disposed on the elevator car and is connected to the elevator control system via a communication bus, wherein the car controller is connected to the in-car display controller, wherein communication between the in-car display controller and the car controller is bi-directional.

20. The main control system of claim 19 comprising transmitting means that allow for remote monitoring of the elevator system.
